(19) United States
(12) Patent Application Publication
(10) Pub. No.: US 2025/0059302 A1
(43) Pub. Date: Feb. 20, 2025

(54) PROCESS FOR REDUCING NITRITE IN MICROCRYSTALLINE CELLULOSE

(71) Applicant: NUTRITION & BIOSCIENCES USA 1, LLC

(72) Inventors: JURGEN ENGELHARDT, WALSRODE (DE); OLIVER PETERMANN, WALSRODE (DE)

(21) Appl. No.: 18/720,023

(22) PCT Filed: Dec. 7, 2022
(86) PCT No.: PCT/EP2022/084807

§ 371 Date: Jun. 14, 2024

(30) Foreign Application Priority Data
Dec. 14, 2021 (EP) 21214301.0

(51) Int. Cl. C08B 15/02

(52) U.S. Cl. CPC C08B 15/02

(57) ABSTRACT

A process for reducing the nitrite content of microcrystalline cellulose (MCC) comprises the step contacting MCC in the form of a powder with ozone in an amount of 0.05-0.6 g of ozone per g of MCC. The nitrite content in MCC is typically reduced by at least 50% by the ozone treatment.

### FIELD

The present invention relates to a process for reducing the level of nitrite in microcrystalline cellulose.

### INTRODUCTION

Microcrystalline cellulose (MCC) is a purified product which is produced by converting fibrous cellulose into a highly crystalline cellulose by selective hydrolytic degradation of amorphous regions of the fibrous cellulose. The sources for the preparation of MCC can be cellulose pulp from fibrous plants materials such as wood or other cellulosic materials such as cotton from linters, stalks, rags or fabric waste. MCC products are used as binders and disintegrants in pharmaceutical tablets and as suspending liquids in pharmaceutical formulations. MCC is widely used as a binder, gelling agent, thickener, texturizer, stabilizer, emulsifier and as fat replacement in food and beverage applications. Moreover, MCC products find use as for example binders or bulking agents in personal care applications, such as cosmetics and dentifrices, or as a binder, bulking agent, disintegrant or processing aid in cosmetics and dentifrices, in industrial applications such as in paint, in household products such as detergents or bleach tablets, and in agricultural formulations.

The classical method for MCC production, which is still the most common manufacturing method, is acid hydrolysis of purified cellulose as for example disclosed in U.S. Pat. Nos. 2,978,446; 3,023,104; and 3,146,168. Following acid hydrolysis, the MCC is typically separated from the reaction mixture, washed to remove degraded by-products and neutralized, e.g. with ammonia. The resulting wet mass typically contains 40% to 60% moisture and is generally referred to by people skilled in the art as ‘hydrolyzed cellulose wet cake’ or ‘microcrystalline cellulose/MCC wet cake’.

The separated microcrystalline cellulose wetcake is subsequently dried to powdered grades of MCC. A wide range of commercial microcrystalline cellulose products are available, for example under the brand name of Avicel®.

It is well-known that impurities in microcrystalline cellulose are glucose, formaldehyde, nitrates and nitrites (“Impact of Excipient Interactions of Solid Dosage Form Stability” by Ajit S. Narang et al., Pharmaceutical Research volume 29, pages 2660-2683 (2012)). Nitrites are present in the cellulose pulp used as starting material or as a result of ammonia neutralization or the use of exhaust gas for drying the MCC wetcake. Nitrite levels in MCC are a concern due to its potentially carcinogenic effect in the human body, for instance via interactions with active pharmaceutical ingredients or impurities containing amine groups which may result in the formation of the carcinogen nitrosodimethylamine or via nitrosamine formation with amine containing food components in the strongly acidic environment of the stomach.

Several methods are known to reduce the concentration of nitrites in aqueous solutions, such as ozonization, catalysis, passing the aqueous solution through activated charcoal, passing the aqueous solutions through ion exchange resins, making use of microalgae or subjecting water/glycol mixtures at elevated pressure and temperatures above 120° C. Evidently these methods are not useful for reducing the concentration of nitrites in MCC when the MCC is in powder form. Thus, there is still the urgent need to find a method of reducing the concentration of nitrite salts that are present in MCC in powder form.

### SUMMARY

An object of the invention is to provide MCC with reduced levels of nitrite.

Accordingly, the present invention relates to a process for reducing the nitrite content of microcrystalline cellulose (MCC) which comprises contacting MCC in the form of a powder with ozone in an amount of 0.05-0.6 g of ozone per g of MCC.

Surprisingly, reduction of nitrite levels by ozone treatment may take place in MCC in dry solid bulk powders within a short period of time and at low temperatures. This is surprising as nitrite is homogenously distributed in the individual MCC particles and the ozone reagent needs to diffuse through the whole particle to remove significant amount of nitrite. Also surprisingly, reduction of nitrite levels by ozone treatment is even achieved when MCC has been neutralized with ammonia. Oxidization of ammonia to nitrite is a well-known reaction. So the person skilled in the art would expect that treatment of ammonia neutralized MCC with the oxidizing agent ozone would rather increase than decrease the content of nitrites in the MCC.

A further advantage of using ozone to reduce the nitrite levels in MCC is the reduced environmental impact as ozone decomposes to oxygen due to its limited half-life.

### DETAILED DESCRIPTION OF THE INVENTION

Microcrystalline cellulose (MCC) is a white, odorless, tasteless, relatively free flowing crystalline powder. It is a purified, partially depolymerized cellulose obtained by subjecting alpha cellulose obtained as pulp from fibrous plant material to hydrolytic degradation, typically with mineral acids. Suitable plant material includes, for example, wood pulp such as bleached sulfite and sulfate pulps, corn husks, bagasse, straw, cotton, cotton linters, flax, kemp, ramie, fermented cellulose, etc. During acid hydrolysis the amorphous regions (and paracrystalline regions) of the cellulosic fibril are selectively hydrolysed while the crystalline regions remain intact, whereby highly crystalline particulate cellulose consisting mainly of crystalline aggregates (MCC) are obtained. The degree of polymerization (DP, the number of anhydroglucose units in the cellulose chain) decreases during the acid hydrolysis and the rate of hydrolysis slows to a certain level-off degree of polymerization (LOPD). The level-off values which can be obtained by means of partial hydrolysis depend mainly on the choice of the above-mentioned raw materials. MCC having an average level-off D.P. in the range of 15 to 60, for example, can be produced from regenerated forms of cellulose. MCC having an average level-off D.P. in the range of 60 to 125 may be obtained from alkali swollen natural forms of cellulose such as cotton linters and purified wood pulps. Sulfite pulp as a source material will typically produce MCC having an average level-off D.P. in the range of 200 to 400. The average level-off degree of polymerization (=D.P.) is determined in agreement with DIN 54 270, parts 1 and 2. The MCC is separated from the reaction mixture and washed to remove degraded by-products. The thus produced MCC is typically at least partially neutralized during or after the washing procedure. Examples of neutralizing agents are, e.g., ammonium bicarbonate, ammonium carbonate, ammonium hydroxide or, preferably, ammonia.

After the washing step the MCC wet cake generally has a moisture content of from 35 to 70 percent, typically from 45 to 60 percent, based on the total weight of the moist MCC. Preferred washing liquors generally are water, brine, or organic solvents in admixture with water, such as aqueous mixtures of isopropanol, ethanol or methanol. More preferred washing liquors generally are water or brine. Preferably MCC obtained directly after hydrolysis, washing and optionally cooling is used as a starting material for the present invention. MCC is generally washed at a temperature of from 10 to 80° C., preferably from 15 to 50° C. A solvent-moist, preferably a water-moist mass is obtained after washing and separating the MCC from the washing liquor. Separating MCC from a suspension can be carried out in a known way, such as centrifugation. The resulting wet mass is referred to in the art by several names, including hydrolyzed cellulose, hydrolyzed cellulose wetcake, level-off DP cellulose, microcrystalline cellulose wetcake or simply wetcake.

It may also be desired to reduce the levels of nitrite in modified MCC, e.g., in colloidal MCC co-processed or co-attrited with a protective hydrocolloid or in MCC wherein other properties have been modified, such as the flowability of MCC.

The term “colloidal MCC” is known in the art, see, e.g. International Patent application WO 94/24866. “Colloidal MCC” designates MCC in such a fine particle form that it behaves as a colloid in an aqueous system. E.g., MCC particles may have been attrited to the point where they are small enough to permit the MCC particles to function like a colloid, especially in an aqueous system. U.S. Pat. No. 6,037,380 describes colloidal MCC as particulate microcrystalline cellulose compositions which may be i) dispersed to form suspensions or ii) dried and the resulting particulate solid dispersed in liquid media to produce a suspension. In the suspension, substantially all microcrystalline cellulose particles are of less than 1 micrometer in size and remain in a colloidal state even when centrifuged. In its preferred embodiment, “colloidal MCC” means MCC after co-processing, for example co-attrition, of MCC with an attriting aid, such as an acid or an inorganic salt and/or with a protective colloid, such as one or more polysaccharides.

The term “attrited” and “attrition” are used interchangeably to mean a process that effectively reduces the size of at least some, if not all, of the particles by application of high shear forces. The term “particles” as used herein includes, among others, the individual particles as well as clusters of particles, often referred to as “aggregates”.

The term “co-attrition” refers to the application of high shear forces to an admixture of the MCC and an attriting aid, such as an acid or an inorganic salt and/or a protective colloid, such as one or more one polysaccharides. Suitable attrition conditions may be obtained, for example, by co-extruding, milling or kneading.

“Co-processing” of the MCC with an attriting aid, such as an acid or an inorganic salt and/or with a protective colloid, such as one or more polysaccharides, may, for example, mean co-attrition, of the MCC with an attriting aid, such as an acid or an inorganic salt and/or with a protective colloid, such as one or more polysaccharides.

For producing colloidal MCC, the MCC wetcake is subjected to an attrition process, for example extrusion, that substantially subdivides the aggregated cellulose crystallites into more finely divided crystallite particles. To prevent hornification, a protective hydrocolloid, e.g. a hydrophilic co-polymer, may be added before, during or following attrition, but before drying. The protective hydrocolloid, wholly or partially, screens out the hydrogen bonds or other attractive forces between the smaller sized particles to provide a readily dispersible powder. Colloidal MCC will typically form stable suspensions with little or no settling of the dispersed solids as for example described in WO2018236965. Carboxymethyl cellulose is a common hydrocolloid used for these purposes, as for example described in U.S. Pat. No. 3,539,365 and WO2018031859. Alginates, pectins, carrageenan may be used as hydrocolloid as for example described in WO2019050598 or WO2013085809. Colloidal MCC products are for example available under the brand names Avicel® and Gelstar®. An important application for colloidal MCC is stabilization of suspensions, e.g. suspensions of solid particles in low viscosity liquids, for example in beverages, such as chocolate milk. In food applications, for example in canned food, shell-stable spreads and salads, frozen desserts, aerosol toppings, meat, dairy and bakery products, colloidal MCC may be used as fat replacement or bulking agent, that is as a non-caloric filler or texture modifier. In pharmaceutical—and personal care applications, such as eye drops, ointments, suspensions and gels, colloidal MCC can be used as a rheology or texture modifier.

MCC can be co-processed, particularly co-attrited, with suitable polysaccharides, which may be cellulose derivatives such as cellulose ethers, for example carboxymethyl cellulose (CMC), hydroxypropyl methylcellulose (HPMC) or methylcellulose (MC); or cellulose ether esters; or polysaccharides which may be isolated from plant exudates as from for example gum Arabic, gum ghatti, gum karaya, gum tragacanth; plant seeds such as starches, locust bean gum, guar gum; seaweed polysaccharides such as agar, carrageenan, furcelleran and alginates; microbial and/or fermentation products such as dextran, xanthan, pullulan, gellan gums; or pectins. In an aspect of the invention the cellulose ether which is co-processed with MCC is carboxymethyl cellulose (CMC). Useful types of carboxymethyl cellulose (CMC) include their salts, preferably their sodium and potassium salts. The CMC is typically used in the form of its sodium salt. In the present context, the term ‘CMC’ is intended to include carboxymethyl cellulose and/or salts of CMC, such as sodium CMC or potassium CMC. The degree of substitution DS, which is the degree of carboxymethyl substitution DS (carboxymethyl), also designated as the degree of the carboxymethoxyl substitution DS (carboxy methoxyl), of the cellulose ether is the average number of OH groups substituted with carboxymethyl groups per anhydroglucose unit. Preferred types of CMC have a DS of at least 0.4, such as at least 0.5, such as at least 0.6. Preferred types of CMC have a DS of up to 1.7, such as up to 1.6, such as up to 1.45. The DS is measured according to ASTM D 1439-03 “Standard Test Methods for Sodium Carboxymethylcellulose; Degree of etherification, Test method B; Non-aqueous Titration”.

Preferred types of CMC have a viscosity of at least 5 mPa·s, such as least 10 mPa·s, such as least 15 mPa·s, such as least 25 mPa·s, such as least 30 mPa·s, measured as a 2% by weight solution in water. Preferred types of CMC have a viscosity of up to 6000 mPa·s, such as up to 3100 mPa·s, such as up to 800 mPa·s, such as up to 100 mPa·s, such as up to 80 mPa·s, measured as a 2% by weight solution in water at 20° C. The viscosity of CMC is measured as a 2% by weight solution in water at 20° C. and at a shear rate of 2.55 s⁻¹ using a Haake VT550 Viscotester.

Preferred types of sodium CMC have a DS of 0.65 to 0.85 and a viscosity of 30 to 80 mPa·s, measured as a 2% by weight solution in water at 20° C.

Attrition may for example be accomplished by extrusion or with other mechanical devices such as refiners, planetary mixers, colloidal mills, beat mills, kneaders and grinders that can provide effective shearing force.

Alternatively, MCC may have been modified in a known manner, e.g., with silica or other inorganic products before its nitrogen content is reduced in the process of the present invention.

A known effect of modification of MCC with silica or other inorganic products is an improved flowability of MCC.

In the present description the term “microcrystalline cellulose” (“MCC”) includes non-modified or modified MCC, e.g., microcrystalline cellulose (MCC) that has or has not been co-processed or co-attrited with a protective hydrocolloid, microcrystalline cellulose (MCC) that is non-colloidal or colloidal and/or microcrystalline cellulose (MCC) that has been surface-treated with silica or another inorganic material.

A final step in manufacturing MCC is drying the MCC wetcake. In commercial manufacturing the drying-step is commonly performed by spray-drying. Typically, the MCC is diluted before spray-drying. In some embodiments, the diluting agent is water, which, in some embodiments comprises an above-described neutralizing agent. A diluted MCC suitable for spray drying is generally in the form of an aqueous slurry of MCC and typically comprises about 10% to 20% MCC and about 80% to 90% water, based on the total weight of dry MCC and water. The desired commercial grades of MCC are obtained by varying and controlling the spray drying conditions in order to manipulate the degree of agglomeration (particle size distribution) and moisture content of the MCC product. [G. Thorens, Int. J. Pharm. (2015), 490, 47-54; G. Thorens, Int. J. Pharm. (2014), 473, 64-72)].

M. Tomar et al., Int. J. Pharm. Sci. Res. (2018), Vol. 9 (4), 1545-1554, disclose several alternative methods for drying MCC wetcake that has been produced by acid hydrolysis of dissolv-ing grade wood pulp and neutralization by washing with water and ammonia. For spray drying water is added to the MCC wetcake to make a suspension which is then dried with the help of a spray dryer. For spin flash drying the MCC wetcake is first broken down into small pieces with a mixer, followed by drying of the material with a spin flash dryer, i.e. the breakdown of wetcake and the subsequent drying of wetcake takes place in two separate unit operations and in separate process devices. For bulk flash drying the MCC wet cake is also first crushed down into small pieces with help of a mixer, followed by drying with a bulk drier.

The dried MCC typically has a moisture content of up to 20%, preferably up to 10%, more preferably up to 5%, by weight of the dry powder. It has been found that a moisture content of more than 20% generally does not result in reduced levels of nitrite and that the most pronounced reduction of nitrite levels is obtained when the moisture content is 5% or less.

The size of the MCC particles is characterized by the particle diameter. In the present context, the particle diameter is considered to be the diameter of a sphere that has the same volume as the particle. The size of the particles in a collection of particles is characterized by parameters of the form DXY, where XY is a two-digit number from 01 to 99. The parameter DXY is a diameter chosen such that XY % of the particles in the collection, by volume, have diameter of DXY or smaller. For example, D90 is the diameter such that 90% by volume of the particles in the collection have a diameter of D90 or less while 10% by volume of the particles have a diameter larger than D90. The MCC particles generally have a D90 of less than 500 μm, preferably a D90 of less than 400 μm, more preferably a D90 of less than 300 μm, and most preferably a D90 of less than 200 μm.

According to the present invention, MCC in the form of a dried powder which typically has the above-mentioned moisture content is generally subjected to agitation while being contacted with ozone, typically by stirring during mixing with ozone gas. The ozone may be supplied by an ozone generator. Ozone can be generated by known techniques, for example by silent electrical discharge of high voltage treating oxygen gas or air. The use of oxygen as feed gas avoids the creation of nitrogen oxides. Alternative processes make use of cold plasma, electrolysis or UV light. The treatment with ozone may preferably take place at a low temperature such as a temperature of 20-25° C.

In the process of the present invention from 0.05 to 0.6 g of ozone per g of MCC are used. The amount of ozone is preferably 0.09-0.5 g per g of MCC, more preferably 0.15-0.35 g ozone per g MCC. It has been found that a concentration of at least 0.7 g ozone per g of MCC generally results in nitrite levels that are higher than in the MCC starting material. The ozone concentration required to reduce a significant proportion of the nitrite in MCC may be adjusted by the treatment time. Preferably MCC is contacted with the ozone for a time period of from 5 to 360 minutes, preferably from 10 to 180 minutes, more preferably from 15 to 100 minutes.

The resulting MCC is in the form of a powder which typically has a content of nitrite of 1.5 ppm or less, preferably 1.0 ppm or less, more preferably 0.60 ppm or less, even more preferably 0.50 ppm or less, and most preferably 0.40 ppm or less, based on the weight of dry MCC. The nitrite content typically originates from ammonium nitrite in the MCC. In the process of the present invention the nitrite content in MCC is typically reduced by at least 50% by the ozone treatment, based on the nitrite content in MCC prior to the ozone treatment. In some embodiments, the nitrite content in MCC is reduced by at least 80% or even at least 90%. The invention is further described in the following examples which is not intended to limit the scope of the invention as claimed.

### Examples

### Determining the Nitrite Content in MCC

The measurements of nitrite were performed on an ion exchange chromatography system (Dionex ICS-6000 system consisting of AS-AP autosampler, quaternary pumps, KOH eluent generator, anion suppressor, conductivity detector, and Chromeleon 7.2.9 Chromatography Data System) with microbore analytical and guard columns (Dionex lonPac AS 19, 2×250 mm, Catalog number 062886 and Dionex lonPac AG 19, 2×50 mm, Catalog number 062888). KOH gradient was simultaneously generated by a KOH eluent generator:-10 min at 1 mmol for equilibration (meaning 10 min pre-equilibration time for the IC column to get equilibrated before the IC method starts to run), 0-15 min from 1 mmol to 20 mmol, 15.1 min to 50 mmol and hold at 50 mmol until 28 min, 28-29 min from 50 mmol to 1 mmol and the run stops at 30 min. The flow rate is at 0.5 mL/min. Anion suppression with ADRS 2 mm suppressor was applied with dynamic mode with starting voltage at 3.8 V. The column temperature was 30° C. and compartment temperature was 15° C. The injection was done with 25 μL sample loop.

For nitrite analysis, the microcrystalline cellulose (MCC) samples were prepared by extracting g of MCC with 15 g of high purity water (electrical resistivity greater than 18 megohm-cm at 25° C., prepared by filtering deionized water through any reliable laboratory water purification system such as the Milli-Q IQ 7003/7005/7010/7015 system from Millipore Sigma) on a shaker at low shaking speed for 30 minutes in a 50-mL centrifuge tube. The tube was then centrifuged at 10000 rpm for 10 min to precipitate MCC (Sorvall Legend XT/XF Centrifuge Series, Catalog 75004541). The clear extraction solution was filtered through 0.45 μm PTFE filter and put into IC autosampler vials for analysis by ion exchange chromatography (IC). The samples were calibrated with external calibration standards prepared at 0.5 μg/g, 0.05 μg/g and 0.005 μg/g with IC analytical standards purchased from Inorganic Ventures (1000 μg/g nitrite (NO2⁻), Part numbers ICNO31-125ML and ICNO21-125ML).

### Dry Content

The dry content of MCC was determined using a Sartorius moisture analyzer MA 150 at 130° C. in automatic mode. Sample size was 2-3 g.

### Series I (Example 1 and Comparative Examples A to F)

MCC that was commercially available under the trademark AVICEL PH-101 was used for the experiments of Series I. AVICEL PH-101 microcrystalline cellulose has a nominal particle size of 50 μm, a moisture content of 3.0%-5.0% and a bulk density of 0.26-0.31 g/ml. AVICEL PH-101 microcrystalline cellulose had been neutralized with ammonia during the production process. 20 g of the ammonia neutralized AVICEL PH101 MCC was charged into a glass reactor and stirred for the entire reaction time. Then ozone gas was continuously fed into the glass reactor. Ozone was produced by an ozone generator (Ozomoatic type SWO-30ST, 20% ozone setting). The ozone concentration in the gas stream was kept constant. Varying ozone concentrations were achieved by changing the reaction time. After reaction vacuum was applied to remove the unreacted ozone. The resulting MCC was discharged from the reactor.

The dry content of the MCC before the ozone treatment, the contact time and contact temperature of the MCC with ozone, the g ozone/g MCC, the dry content of the MCC after the ozone treatment and the nitrite content of the MCC after the ozone treatment are listed in Table 1 below.

TABLE 1

| | Dry | contact | Contact | | Dry content | Nitrite |
|---|---|---|---|---|---|---|
| | content | time | temperature | g ozone/ | after reaction | content |
| Example | [%] | [min.] | [° C.] | g MCC | [%] | [ppm] |
| Starting material | 95.3 | — | — | — | . | 4.6 |
| Comp. Ex. A | 95.3 | 60 | Room temp | 0.80 | NA | 3.1 |
| Example 1 | 95.3 | 60 | Room temp | 0.35 | NA | 0.5 |
| Comp. Ex. B | 95.3 | 120 | Room temp | 1.60 | NA | 6.0 |
| Comp. Ex. C | 80.0 | 120 | Room temp | 0.70 | 94.4 | 5.1 |
| Comp. Ex. D | 70.0 | 120 | Room temp | 0.70 | 94.4 | 8.0 |
| Comp. Ex. E | 95.3 | 120 | 63° C. | 0.70 | NA | 10.7 |
| Comp. Ex. F | 80.0 | 120 | 63° C. | 0.70 | 96.6 | 18.2 |

NA: Not assessed

### Series II (Examples 2-6 and Comparative Example G)

The same starting material was used as in Series I. The procedure in Series I was repeated, but the experiments in Series II were done at a different time than the experiments in Series I. This explains the slightly different results in Series I and in Series II. The results are listed in Table 2 below.

TABLE 2

| | Dry | contact | Contact | | Dry content | Nitrite |
|---|---|---|---|---|---|---|
| | content | time | temperature | g ozone/ | after reaction | content |
| Example | [%] | [min.] | [° C.] | g MCC | [%] | [ppm] |
| Example 2 | 95.3 | 100 | Room temp | 0.58 | 95.0 | 1.1 |
| Example 3 | 95.3 | 80 | Room temp | 0.47 | 95.4 | 0.80 |
| Example 4 | 95.3 | 60 | Room temp | 0.35 | 94.9 | 0.56 |
| Example 5 | 95.3 | 30 | Room temp | 0.18 | 93.6 | 0.32 |
| Example 6 | 95.3 | 15 | Room temp | 0.09 | 94.0 | 0.38 |
| Comp. Ex. G | 80.0 | 120 | 90° C. | 0.70 | 95.6 | 33.88 |

NA: Not assessed

The results in Table 1 above illustrate that ozone levels of at least 0.7 g ozone/g MCC generally result in higher nitrite levels in MCC powder than in the untreated MCC starting material, whereas ozone levels of only 0.35 g ozone/g MCC result in a nitrite reduction of about 80%, compared to the starting material.

The results in Table 2 above confirm this finding. Ozone levels of only 0.18 g ozone/g MCC and only 0.09 g ozone/g MCC result in a nitrite reduction in MCC powder of even more than 90% compared to the starting material.

1. A process for reducing the nitrite content of microcrystalline cellulose (MCC) comprising contacting MCC in the form of a powder with ozone in an amount of 0.05-0.6 g of ozone per g of MCC.

2. The process according to claim 1, wherein the MCC is contacted with the ozone for 5-360 minutes.

3. The process according to claim 1, wherein the powder of MCC has a moisture content of up to 20% by weight of dry MCC powder.

4. The process according to claim 1, wherein the MCC is contacted with ozone at a temperature of 20-25° C.

5. The process according to claim 1, wherein the MCC is subjected to agitation while being contacted with ozone.

6. The process according to claim 1, wherein the amount of ozone is 0.09-0.5 g of ozone per g of MCC.

7. The process according to claim 1, wherein the amount of ozone is 0.15-0.35 g of ozone per g of MCC.

8. The process according to claim 1, wherein the MCC is contacted with the ozone for 10-180 minutes.

9. The process according to claim 1, wherein the MCC is prepared by acid hydrolysis of alpha cellulose obtained as pulp from fibrous plant material, and the resulting MCC is washed and at least partially neutralized during or after the washing procedure with a neutralizing agent selected from ammonium bicarbonate, ammonium carbonate, ammonium hydroxide and ammonia.

10. The process according to claim 1, wherein the MCC is colloidal MCC obtained by co-processing of microcrystalline cellulose with an attriting aid or a protective colloid or both.

11. The process according to claim 10, wherein the colloidal MCC is obtained by co-processing of microcrystalline cellulose with a polysaccharide.

12. The process according to claim 11, wherein the polysaccharide is carboxymethyl cellulose.

13. A microcrystalline cellulose in the form of a powder which is preparable by the process of claim 1 and has a content of nitrite of 1.5 ppm or less, based on the weight of dry MCC.

14. The microcrystalline cellulose of claim 13 which has a nitrite content of 1.0 ppm or less.
